(19) United States
(12) Patent Application Publication
(10) Pub. No.: US 2019/0168477 A1
(43) Pub. Date: Jun. 6, 2019

(54) SETTING STAMPING DIES IN A PRESS WITH OVERHEAD WINCHING CRANE

(71) Applicant: Ford Motor Company, Dearborn, MI (US)

(72) Inventors: Gordon Cleere, Tecumseh, MI (US); George Stanczuk, Amhertsburg (CA); Franklin J. Bishop, Wales, MI (US)

(21) Appl. No.: 15/832,182

(22) Filed: Dec. 5, 2017

(51) Int. Cl. B30B 15/02; B21D 37/14; B66C 1/24

(52) U.S. Cl. CPC B30B 15/028; B21B 15/0042; B66C 1/24; B21D 37/14

(57) ABSTRACT

An apparatus for removing and replacing a die in a press with an overhead crane movable in a first direction. A hoist assembly is mounted on the crane to be movable perpendicular to the first direction. A drum is rotated about an axis of rotation parallel to the first direction. A press includes a die that is movable into and out of the press reciprocally and perpendicular to the first direction. A method for setting a die in a press includes the steps of positioning an overhead crane to be centered relative to a front opening in a press. Pulling the die with a sling attached to a wire rope wound on the drum. The wire rope pulls the die in a direction perpendicular to the axis of rotation of the drum.

### TECHNICAL FIELD

This disclosure relates to a method and apparatus for moving dies into and removing dies from a press with an overhead crane.

### BACKGROUND

Dies are set in a press but must be removed and replaced to service the dies and change over from one die set to another. Dies are placed on a bolster plate that may include a motor drive that is used to move the die into and out of the press. Dies may also be moved with an overhead crane.

The orientation of the press and the direction that the die is moved into and out of the press is normally fixed in one reciprocal sliding direction. As shown in FIG. 1, a prior art overhead crane 10 is normally provided with a hoist 12 that includes a drum 14 that is rotated about a drum rotation axis by a hoist motor 16 and gear reducer 18. If the sliding direction is aligned with the drum rotation axis, a “side pull” condition is created that may damage the wire rope 20. The drum 14 may have helical grooves 22 that the wire rope 20 is wrapped around. In a side pull condition, the wire rope 20 may work against the grooves 22. Pulling a heavy die 24 with a wire rope 20 in a direction transverse to the grooves 22 may adversely affect the stability of the crane 10 and cause wear of the wire rope 20.

This disclosure is directed to solving the above problems and other problems as summarized below.

### SUMMARY

According to one aspect of this disclosure, an apparatus is disclosed for removing and replacing a die in a press with an overhead crane. The apparatus includes an overhead crane movable in a first direction. A hoist assembly is mounted on the crane to be movable perpendicular to the first direction. The hoist assembly includes a drum rotated about an axis of rotation parallel to the first direction. A press includes a die that is movable into and out of the press reciprocally and perpendicular to the first direction.

According to other alternative aspects of this disclosure as it relates to the apparatus, the overhead crane is positioned in the first direction to center the hoist relative to an indicator at the center of the press. A load cell may be operatively connected between the drum and a hook attached to a wire rope to measure the load applied when the die is moved into and out of the press. A guard oriented parallel to and spaced from the crane girder may be attached to a crane girder to restrict the angle of a wire rope relative to the hoist assembly. A sensor system may be disposed in a sheave pocket defined by the hoist assembly for limiting the swing of a wire rope hanging from the hoist apparatus.

According to another aspect of this disclosure, a method is disclosed for setting a die in a press. The method includes the steps of positioning an overhead crane to be centered relative to a front opening in a press and securing a sling to the die. The die is then pulled with the sling attached to a wire rope wound on a drum disposed above the press. The wire rope pulls the die in a direction perpendicular to the axis of rotation of the drum.

According to other aspects of the method, the die may be removed from the press by pulling the die onto a skid adjacent to the front opening. The die may be inserted into the press by pulling the die off of the skid and into the press with the sling extending through a back opening in the press located on the opposite side of the press from the front opening.

The method may also include measuring the load applied to the wire rope with a sensor operatively attached between the wire rope and the drum, and limiting the load to a predetermined level. In addition, the swing angle of the wire rope relative to the drum may be monitored with a sensor system to limit the swing angle of the wire rope to a predetermined degree.

The above aspects of this disclosure and other aspects will be described below with reference to the attached drawings.

### BRIEF DESCRIPTION OF THE DRAWINGS

FIG. 1 is diagrammatic side elevation view of an overhead crane moving a die with a side pull orientation according to the prior art.

FIG. 2 is a diagrammatic front elevation view of an overhead crane moving a die relative to a press according to this disclosure.

FIG. 3 is a diagrammatic side elevation view of an overhead crane pulling a die from a press onto a skid according to this disclosure.

FIG. 4 is a diagrammatic side elevation view of an overhead crane pulling a die from a skid into the press according to this disclosure.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

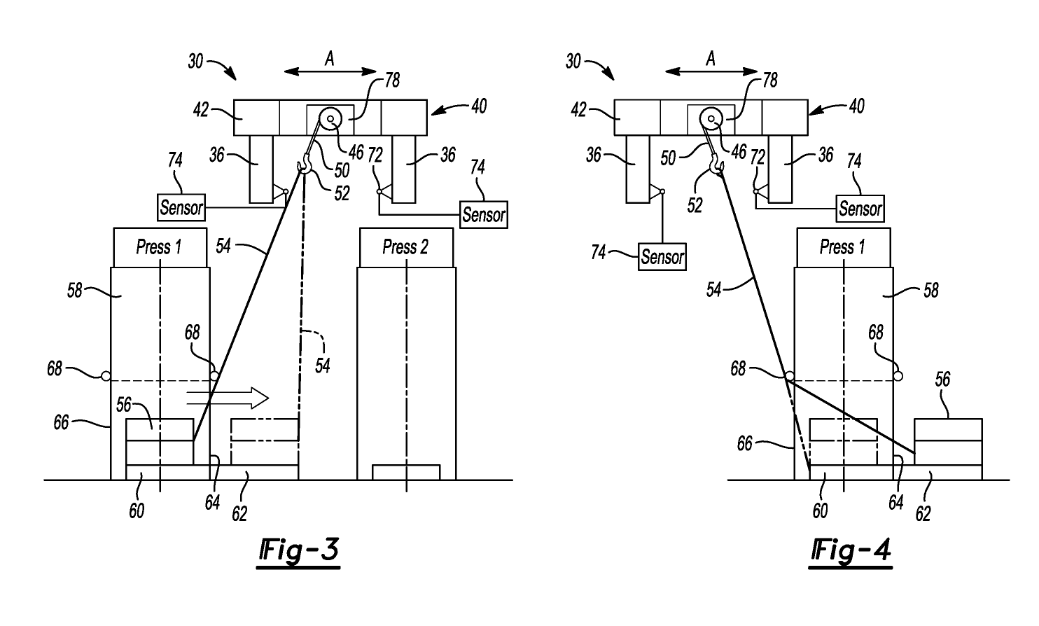

Referring to FIG. 2, an improved overhead crane 30 is shown that rides in a first direction A (shown in FIGS. 3 and 4) along a support beam 32 that is part of a building 34. The overhead crane 30 includes a pair of girders 36 that support a hoist assembly 40. The hoist assembly 40 moves in a direction B along the girder 36.

The hoist assembly 40 includes a trolley 42 that includes wheels 44. The trolley 42 moves on the wheels 44 to change the position of the hoist assembly 40 relative to the girders 36.

The hoist assembly 40 includes a drum 36 that is provided with a helical groove 48. A wire rope 50 is wound on the drum 46 in the helical groove 48. A hook 42 is connected to the wire rope 50 and a sling 54 is connected to the hoist assembly 40 by the hook 42. The sling 54 is rigged to a die 56 that is installed in a press 58. The die 56 is pulled from the press 58 by the sling 54. The die 56, when in the press 58, is attached to a bolster 60. When the die 56 is removed from the press 58, the die slides onto a skid 62 that is located adjacent to the bolster 60. The die 58 is removed from the press 58, through a front die opening 64. The die 56 is set in the press 58 by pulling the die 56 with the sling 54 being routed through a rear die opening 66 to the die 56 on the skid 62. A press cable guard 68 is provided above the front die opening 64 and also above the rear die opening 66. The press cable guard 68 protects the press 58 from the sling 54.

A press centerline indicator 70 is provided on the press 58 and a wire rope 50 and hook 52 are positioned in line with the press centerline indicator by moving hoist assembly 40 with the trolley 42. The hoist assembly 40 should be centered relative to the press 58 to remove or set the die 56 in the press 58. A girder guard 72 is provided on the girder 36 to positively limit the angle of the wire rope relative to the vertical. The girder guard 72 is located to limit the angle of the wire rope 50 relative to vertical to less than 25 degrees. The design angle relative vertical is 20 degrees. The girder guard 72 also protects the girder from being contacted by the wire rope 50. A sensor may be provided on the girder guard 70 or inside a sheave pocket 78.

A load cell 76 is shown in FIG. 2 to be either assembled to the drum 46 or operatively connected between the wire rope 50 and the drum 46. Alternatively, the sensor may be incorporated in the hook 52 or the hook mounting structure. A load cell is monitored by a controller to limit the pulling load for a crane. For example, a 50-ton crane may have a pulling load limit of between 29,000 and 32,000 pounds, or approximately 60% of the rated load capacity.

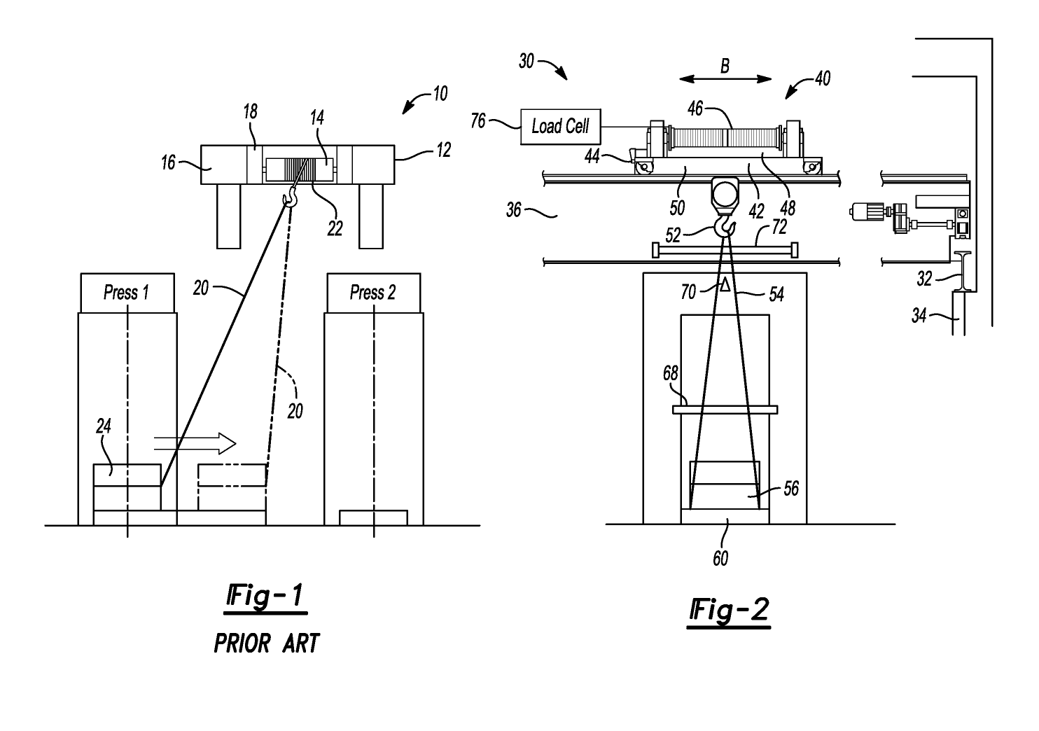

The drum has an axis of rotation that is parallel to the direction B as shown in FIG. 2. The axis of rotation of the drum 50 is perpendicular to the direction A shown in FIGS. 3 and 4 and is also parallel to the direction that the girders 36 move along the support beam 32. The axis of rotation of the drum 50 is oriented to pull the die in a direction tangential to the helical groove 48 with the wire rope 50. This orientation is referred to as a straight pull as the drum 46 is oriented perpendicular to the orientation of the drum 14 shown in FIG. 1 that pulls the die in a side pull condition.

Operation of the improved overhead crane 30 is described with reference to FIGS. 3 and 4. A die is pulled as shown in FIG. 3 through the front die opening 64 from the bolster 60 to the skid 62. The sling 54 is attached to the die 56 to pull the die 56. The wire rope 50 and hook 52 are attached to the sling 54. The hoist assembly 40 is aligned with the centerline indicator 70 (as shown in FIG. 2). The hoist assembly 40 retracts the wire rope 50 by winding the wire rope 50 on the drum 46 with the wire rope 50 being received in the helical groove 48. The die 56 is moved in the direction of the arrow shown in FIG. 3 through the front opening 64 and on to the skid 62. The angle of the wire rope is limited by the girder guard 72 to a maximum angular orientation relative to the vertical direction. The load cell 76 monitors the load as the die 56 is pulled from bolster 60 to be sure that the capacity of the overhead crane 30, the wire rope 40, or sling 54 is not exceeded. The angle that the wire rope is pulled may be limited by a sensor system 74 located within the sheave pocket 78 or on the girder guard 72.

Referring to FIG. 4, the hoist assembly 40 is shown in position to set the die 56 in the press 58. The sling 54 is connected to the die 56 through the rear die opening 66. The sling 54 is routed under the press cable guard 68. The sling 54 is then pulled with the hook 52 and wire rope 50 by winding the wire rope 50 on the drum 46. The sling 54 slides the die 56 from the skid 62 to the bolster 60. As previously described with reference to FIG. 3, the hoist assembly 40 must be centered with the press centerline indicator 70 (shown in FIG. 2) and the angle of the sling 54 or wire rope 50 is limited either by the girder guard 72 or by the sensor system 74. Once again, the load cell 76 (shown in FIG. 2) is used to monitor to the tension applied by the hoist assembly to the wire rope 50.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. An apparatus comprising:
an overhead crane movable in a first direction;
a hoist assembly mounted on the overhead crane and movable perpendicular to the first direction, the hoist assembly including a drum rotated about an axis of rotation parallel to the first direction; and
a press including a die reciprocally movable into and out of the press perpendicular to the first direction.

2. The apparatus of claim 1 wherein the overhead crane is positioned in the first direction to center the hoist assembly relative to the center of the press.

3. The apparatus of claim 1 further comprising:
a load cell built into the drum for measuring a load applied when the die is moved into and out of the press by a wire rope attached to a hook.

4. The apparatus of claim 1 further comprising:
a guard attached to a crane girder to restrict an angle of a wire rope relative to the hoist assembly.

5. The apparatus of claim 4 wherein the guard is a bar oriented parallel to and spaced from the crane girder.

6. The apparatus of claim 1 further comprising:
a sensor system defined by the hoist assembly for limiting swing of a wire rope hanging from the hoist assembly.

7. A method of setting a die in a press comprising:
positioning an overhead crane to be centered relative to a front opening in a press;
securing a sling to the die; and
pulling the die with the sling attached to a wire rope wound on a drum having an axis of rotation that is above the press, wherein the wire rope pulls the die in a direction perpendicular to the axis of rotation.

8. The method of claim 7 wherein the die is removed from the press by pulling the die onto a skid adjacent to the opening.

9. The method of claim 8 wherein the die is inserted into the press by pulling the die from the skid and into the press with the sling extending through a back opening in the press located on the opposite side of the press from the front opening.

10. The method of claim 7 further comprising:
measuring a load applied to the wire rope with a sensor operatively attached between the wire rope and the drum; and
limiting the load to a predetermined level.

11. The method of claim 7 further comprising:
monitoring a swing angle of the wire rope relative to the drum with a sensor system; and
limiting the swing angle of the wire rope to a predetermined degree.

12. The method of claim 7 wherein in the positioning step the overhead crane is moved parallel to the axis of rotation.
